(19) United States
(12) Patent Application Publication
(10) Pub. No.: US 2020/0195048 A1
(43) Pub. Date: Jun. 18, 2020

(54) One Touch Charger

(71) Applicants: Peter Kulukurgiotis, Cambridge, MD (US); Stella Kulukurgiotis, Cambridge, MD (US)

(72) Inventors: Peter Kulukurgiotis, Cambridge, MD (US); Stella Kulukurgiotis, Cambridge, MD (US)

(21) Appl. No.: 16/709,916

(22) Filed: Dec. 10, 2019

Related U.S. Application Data
(63) Continuation-in-part of application No. 15/796,833, filed on Oct. 29, 2017.

(51) Int. Cl. H02J 50/10; H01F 7/02

(52) U.S. Cl. CPC H02J 50/10; H01F 7/0221

(57) ABSTRACT

The current invention is a wireless charger for QI devices. The charger contains a radio wave circuit, powered by the alternating current sent to the Qi wireless transmitter. Alternating current flowing within the transmitter coil creates 5 v dc to charge a device. The Charger contains an ON/OFF button allowing the product to turn off

### CROSS-REFERENCES TO RELATED APPLICATIONS (IF ANY)

None.

### BACKGROUND

### 1. Field of the Invention

This invention relates to chargers and more particularly chargers that charge electronic devices like smartphones.

### 2. Description of Prior Art

The world is becoming increasingly wireless More and more people are using electronic communication devices such as smartphones and tablets to keep in touch. It is important for work and emergencies to keep your phone charged for access.

It is frustrating and can even be dangerous when someone need to communicate and find themselves out of power.

There is still room for improvement in the art.

### SUMMARY OF THE INVENTION

The current invention is a wireless universal radio wave charger for QI compatible devices such as smartphones and tablets that charges your devices with radio waves found in the air. The charger contains a radio wave circuit that's, powered by the alternating current sent to step up voltage regulator that coverts o, 5 v from radio wave circuit to 5 v de to charge your devices. Alternating current sent to qi wireless power transmitter creates a magnetic which charges the battery of the electrical device.

It is an improvement over existing art.

### BRIEF DESCRIPTION OF THE DRAWINGS

Without restricting the full scope of this invention, the preferred form of this invention is illustrated in the following drawings:

FIG. 1 shows the wireless charger in a charging position;

FIG. 2 shows another view of the charger in a charging position;

FIG. 3 shows a right side view of the charger in a charging position;

FIG. 4 shows a left right side view of the charger in a charging position;

FIG. 5 shows some of the components of the wireless charger; and

FIG. 6a shows a diagram of the radio wave circuit;

FIG. 6b shows a printed circuit board;

FIG. 7 shows the radio wave circuit connected to the printed circuit board; and

FIG. 8 shows the circuit diagram of the on/off switch.

### DESCRIPTION OF THE PREFERRED EMBODIMENT

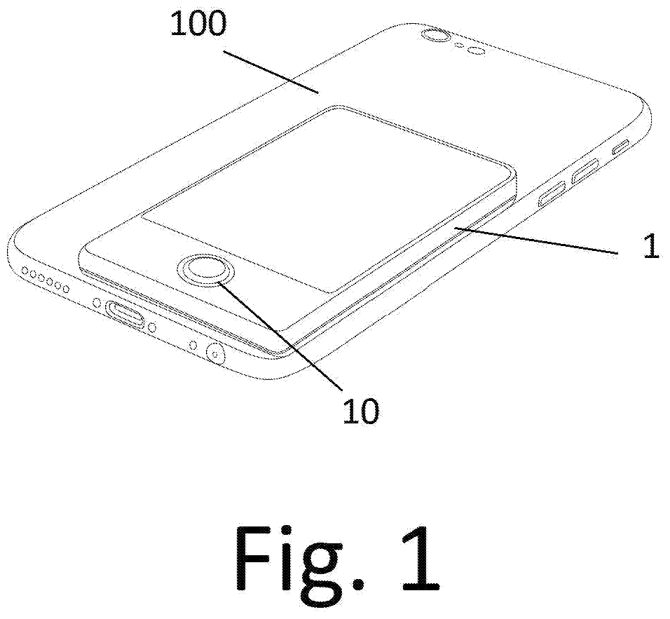

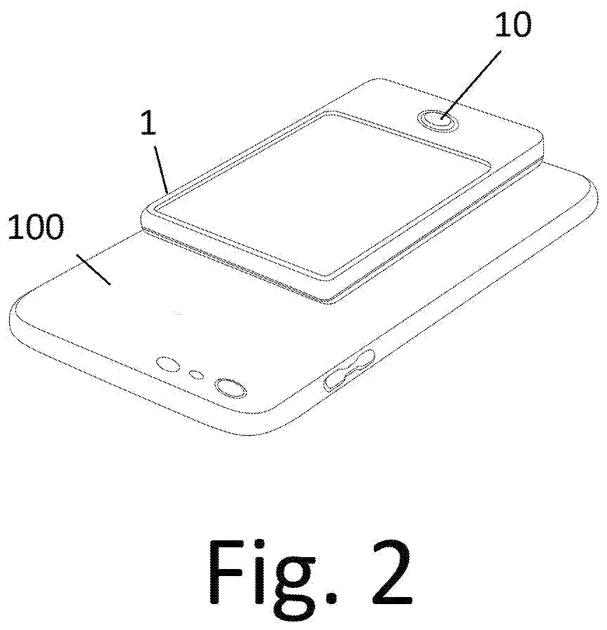

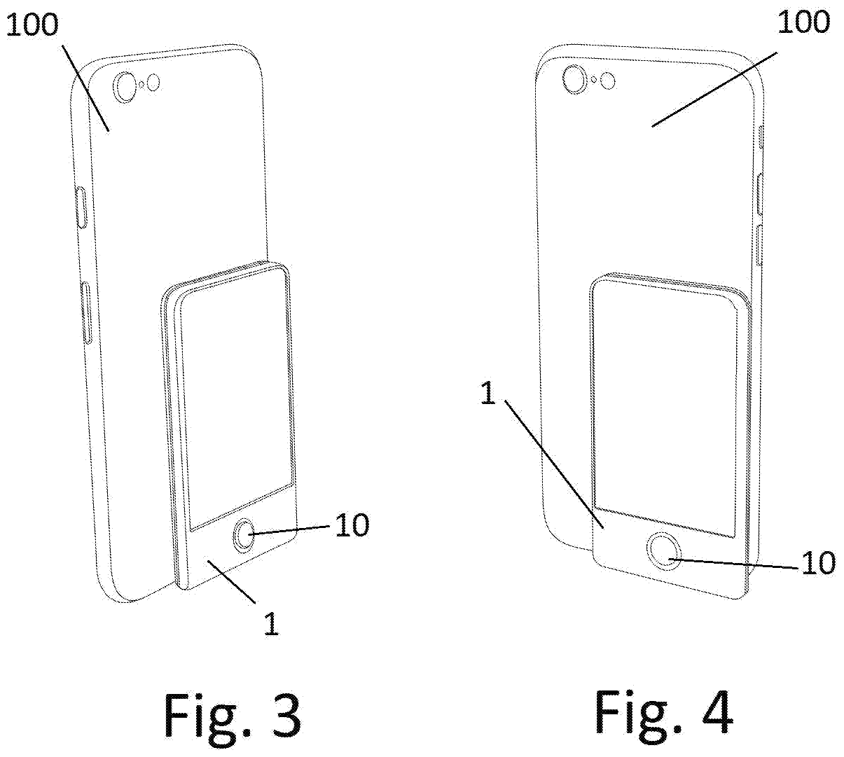

As shown in FIGS. 1 through 8, the current invention is a wireless charger 1 used to wirelessly charge an electronic device 100.

The charger 1 is designed to charge smartphones and tablets and any device QI compatible. Qi is an open interface standard developed by the Wireless Power Consortium for inductive charging over distances of up to 4 cm (1.6 inches). The charger 1 is placed next to the device 100 to be charged as shown in FIG. 1 through 4 to charge via resonant inductive coupling.

The Charger 1 is portable within a thin rectangular case with rounded edges in the preferred embodiment. The design of the current invention is such that the devices 100 can be charged without having to set them down.

In the preferred embodiment, the charger 1 charges itself with RF wave technology using an antenna 30 as a source of electricity produced called radio frequency waves. This allows the charging of the devices 100 without the need to set it down and with no need for cables or wires.

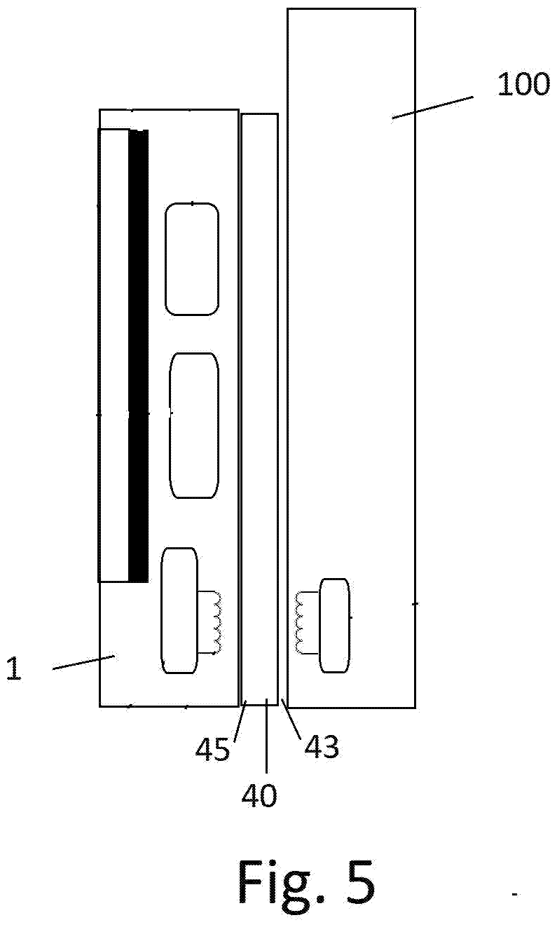

The charger 1 will have a magnetic stick pad 40 as shown in FIG. 5. The magnetic stick pad 40 has two sides: adhesive 43 and magnetic 45. The adhesive side sticks to the back of the device 100, while the magnetic side attaches to the Charger 1. It's that simple for constant charge on the go.

As shown in FIG. 5, the Charger 1 contains a radio waves circuit powered by step up voltage regulator the alternating current sent to the Qi transmitter coil charges the battery of the electrical device 100.

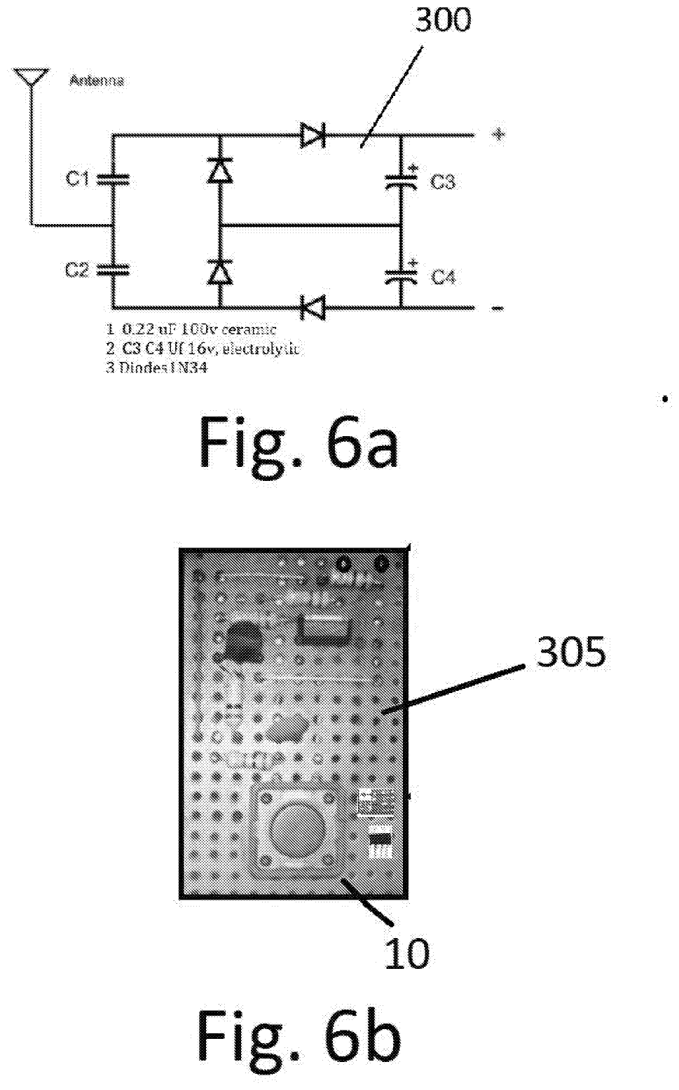

FIG. 6a shows a radio wave circuit 300 diagram. The radio wave circuit 300 is connected to a Printed Circuit Board 305 (FIG. 6b).

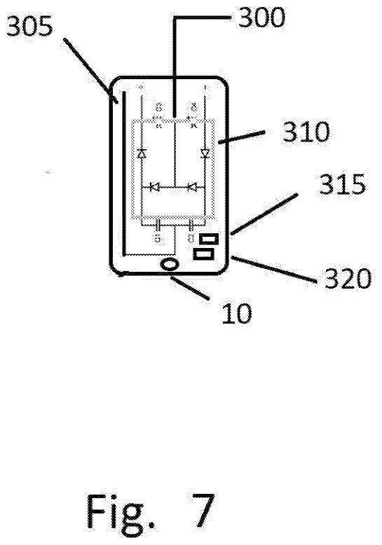

FIG. 7 shows the wave circuit 300 connect to a breadboard 305. The PCB board 305 will provide a source of power approximately producing up to 0.5 v. The radio wave circuit 300 is used to power the step up voltage regulator chip at 0.5 v which then efficiently generates 5 v DC power supply to charge the devices 100.

A Qi transmitter 310 connects to the breadboard 305 allowing devices 100 to be charged wirelessly.

A step up voltage regulator chip 315 is connected to the breadboard 305 that produces 5 v to charge a device 100 from input voltages produced from the radio wave circuit 300. The step up voltage regulator chip 315 generates 5 v from input voltages as low as 0.5 v.

This is used to power the step up voltage regulator chip at 0.5 v which then efficiently generates 5 v DC power supply to charge the devices 100.

A 5 v regulator 320 is designed to keep voltage to a constant 5 v to charge a device 100.

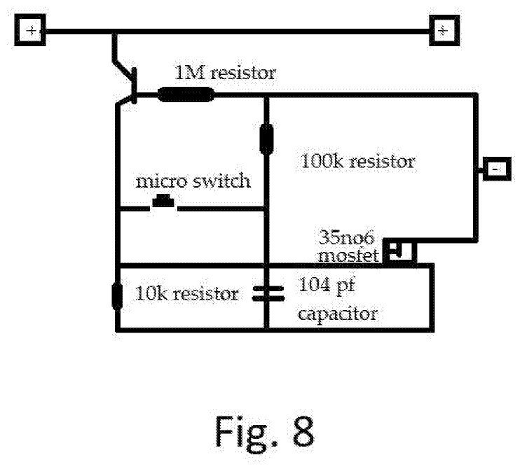

The Charger 1 will have an on/off switch 10. The circuit diagram for the on/off switch 10 is shown in FIG. 8. The on/off switch is attached to the printed circuit board 305.

### Advantages

The current invention changes the way devices are charged for good. No more setting down and waiting. No more need for cables, wires and annoying adaptor plugs. No more USB cords or heavy case chargers taking up space. It sticks conveniently to the back of the device.

Although the present invention has been described in considerable detail with reference to certain preferred versions thereof, other versions are possible such as different tension means, bobber shapes and sizes and different colored lights. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A charger comprising:
radio wave circuit that is powered by step up voltage regulator 5 v sent to a transmitter coil creating a magnetic field which extends to the qi wireless power transmitter to allow a device to be charged, a magnetic stick pad with two sides, an adhesive and magnetic side where the adhesive side sticks to the back of the device and the magnetic side attaches to the device, and
charged with RF wave technology using an
antenna.

2. The charger according to claim 1 further comprising:
Where the case is rectangular in
shape.

3. The charger according to claim 1 further comprising:
Having magnetic stick pad with two sides: an adhesive and magnetic side where the adhesive
side sticks to the back of the device and the magnetic side attaches to the device.

4. The charger according to claim 1 further comprising
Having a On/off button to turn off the device.
